(19) United States
(12) Patent Application Publication
(10) Pub. No.: US 2002/0043922 A1
(43) Pub. Date: Apr. 18, 2002

(54) Display device, production process thereof and flat cathode-ray tube

(75) Inventors: Tomoji Oishi, Hitachi (JP); Masahiro Nishizawa, Mobara (JP); Norikazu Uchiyama, Chikura (JP); Maki Taniguchi, Ichihara (JP); Toshio Tojo, Ichinomiya (JP)

Correspondence Address: CROWELL & MORING, L.L.P., P.O. Box 14300, Washington, DC, 20044-4300, US

(73) Assignee: Hitachi, Ltd.

(21) Appl. No.: 09/964,497

(22) Filed: Sep. 28, 2001

(30) Foreign Application Priority Data
Sep. 29, 2000 (JP) 2000-301104

(51) Int. Cl. H01J 29/10

(52) U.S. Cl. 313/461

(57) ABSTRACT

A display device having a surface treating film formed on the outer surface of a substrate of the display device, said surface treating film having a property of changing light transmittance or refractive index by light or UV rays, and/or containing a compound which can be deposited by irradiation with light, shows excellent antireflective antistatic properties and low surface resistance, and can be applied to flat cathode-ray tubes.

### BACKGROUND OF THE INVENTION

The present invention relates to a novel display device, a process for producing the same and a flat type cathode-ray tube.

As a typical display device, cathode-ray tubes are known. Recently, flat type cathode-ray tubes are becoming a main product. With an increase of a demand for higher image quality of television, cathode-ray tubes having various surface treating films (e.g. antireflection film, antistatic film, etc.) on a front surface of faceplate thereof have been produced. As to antireflective antistatic films, those having a low resistance and a low reflection are required and in order to improve contrast, a wavelength selective absorption film is to be produced (JP-A-1-320742, JP-A4-14738).

With spread of flat type cathode-ray tubes (CRT), there have arisen the following problems at a time of forming surface treating films on CRT surfaces. In the flat type CRTs, the outermost surface is flat, but the inner surface has a curved structure with a curvature. Thus, the glass of CRT panel has different light transmittances in the central portion and peripheral portion. Generally speaking, the difference in light transmittances is about 10 to 20%. As a result, there arose a problem of causing different emission intensities in the central portion and peripheral portion when emission from the CRT emitting body passes through the panel.

Further, when a surface treating film such as a antireflective antistatic film or a wavelength selective absorption film was formed for such flat type CRT, since the film thickness of the film formed on the surface was uniform and the light transmittance of the surface treating film was uniform in the central portion and the peripheral portion, there arose another problem of strengthening color changes of emitted light from the emitting body of CRT in the central portion and the peripheral portion in the case of passing through the panel.

In order to solve the above-mentioned problems, there are proposed processes for forming transmittance adjusting films on an outer surface of flat cathode-ray tube.

For example, JP-A-11-307106 proposes formation of a film having different thickness in the central portion and peripheral portion by vacuum evaporation to compensate the transmittance. JP-A-11-307018 and JP-A-11-307019 propose to form resin plates having different thicknesses in the central portion and peripheral portion and each resin plate being adhered to the surface in order to compensate the transmittance. In order to solve the above-mentioned problems, it was necessary to regulate the film thicknesses of the transmittance adjusting films severely, but controlling was difficult.

On the other hand, JP-A-11-233050 proposes a colored film by adding cobalt oxide, nickel oxide, graphite, etc. to an organic resin film for compensating the transmittance. JP-A-10-177850 discloses, but not concretely, a method for coloring a resin film, a method for coating a metal oxide on a resin film and a method for coloring an adhesive. But, since the transmittance distribution in the film charged depending on diffusion of colored compounds, etc., controlling was difficult.

### BRIEF SUMMARY OF THE INVENTION

It is an object of the present invention to provide a display device wherein light transmittances in the central portion and the peripheral portion of a cathode-ray tube are compensated and difference in emission intensities is small, a process for producing such a display device and a flat type cathode-ray tube using such a display device.

### BRIEF DESCRIPTION OF THE DRAWINGS

FIG. 1 is a cross-sectional view of a flat type cathode-ray tube having a three-layered antireflective antistatic inclined absorption film as a surface treating film according to the present invention.

FIG. 2 is an enlarged view of A in FIG. 1.

### DETAILED DESCRIPTION OF THE INVENTION

The display device of the present invention comprises a substrate for displaying an image and a surface treating film formed on an outermost surface of the substrate, said surface treating film having at least one of properties of having partially different light transmittances, having different refractive index, having partially different surface resistance, by changing irradiation of light or ultraviolet rays, and containing a compound which can be deposited by irradiation with light or ultraviolet rays, e.g., silver and a halide and having partially different light transmittance.

Further, when the surface treating film contains SiO₂ and a derivative thereof, preferably has an light transmissible electroconductive layer thereon, and more preferably has a SiO₂ film having a low refractive index on the electroconductive layer, reflection and static electrification can be prevented effectively.

The present invention further provides a process for producing such a display device, which comprises

coating a solution comprising ultrafine particles of metal, an alkoxysilane compound and silica sol on a surface of a substrate for displaying an image,

drying the coated surface, and

irradiating the coated surface with ultraviolet rays changing irradiation intensity partly to form a surface treating film.

The present invention still further provides a flat type cathode-ray tube including a phosphor screen therein, which comprises a surface treating film formed on an outer surface of the cathode-ray tube, said surface treating film having smaller light transmittance in a central portion than that in a peripheral portion, or said surface treating film having larger surface resistance in a central portion than that in a peripheral portion, and containing a silver halide compound.

The surface treating film of the present invention can be formed from a solution comprising (a) ultrafine particles of metal such as Ag, ultrafine particle colloid of Ag—Pd—Au, etc, (b) an alkoxysilane compound and (c) silica sol.

As the alkoxysilance compound, there can be used silane coupling agents mentioned below.

The components (a), (b) and (c) can preferably be used in a weight ratio of 1:1:1 to 3:2:1 in order to obtain a uniform mixture and to easily adjust the depositing amount of the silver.

In the present invention, the surface treating film formed on the substrate is characterized by changing its transmittance in an inclined state, changing its surface resistance in an inclined state, and/or changing its refractive index, by changing irradiation of light or ultraviolet (UV) rays.

In addition, the surface treating film formed on the substrate is characterized by containing a compound which can be deposited by irradiation with light or UV rays, for example, Ag and a halide and changing its light transmittance in an inclined state, or containing SiO₂ and a derivative thereof. The surface treating film may form thereon the electroconductive layer, which may further form thereon the SiO₂ layer having a low refractive index successively to form a laminated layer.

As the derivatives of SiO₂, there can be used compounds having a SiO₂ skeleton and organic functional groups. These compounds can be formed by using as a starting material silane coupling agents such as vinyltriethoxysilane, bromopropyltriethoxysilane, chloropropyltriethoxysilane, iodopropyltriethoxysilane, □-glycidoxypropyltrimethoxysilane, □-aminopropyltriethoxysilane, □-(3,4-epoxycyclohexyl)ethyltrimethoxysilane, etc.

In the production of the surface treating film, irradiation of ultraviolet rays after the formation of the surface treating film is conducted by changing the irradiation intensity in an inclined state to incline the light transmittance of the film. By applying this process, a flat type cathode-ray tube can be produced.

More concretely, the surface treating film having a property of adjusting light transmittance can easily be formed by using a filter having 0% transmittance at the periphery portion and 100% transmittance at the central portion. Thus, in the central portion, the light is irradiated most strongly. As the light, the use of laser beams with intensity of 5 to 36 mW/cm² is preferable. By irradiating the light on the film formed by coating the solution mention above, there can be obtained the surface treating film having a difference in light transmittance between the central portion and the peripheral portion in the range of about 10 to 30%, a difference in the refractive index between the central portion and the peripheral portion in the range of 1.4 to 1.8, and a difference in the surface resistance between the central portion and the peripheral portion in the range of 5000 to 100,000 Ω/unit square.

The surface treating film is a film having a property of being colored with a change of transmittance of the film by irradiation of ultraviolet rays. The degree of coloring can be adjusted by the intensity of ultraviolet rays. That is, by changing the intensity of ultraviolet rays from the center portion to the peripheral portion, it is possible to change the transmittance of the film from the center portion to the peripheral portion in an inclined state. This film preferably contain silica as a major component.

It is possible to use a film containing halogenated ions, e.g. Cl⁻, Br⁻, I⁻, etc. therein. The source of halogen is alkali halides, alkoxysilanes bonding chlorine, bromine or iodine or derivatives thereof. The halogen ions can be introduced into the film. The use of silver compounds having halogenated ions is preferable. It is possible to use compounds, other than the silver halides, which can be deposited by irradiation of light or UV rays. When the film is irradiated with ultraviolet rays, silver halide is formed in the film by the light energy of the ultraviolet rays to color the film. The degree of coloring depends on the produced amount of silver halide. Further, since the film is colored and transmittance of the film is also changed, the absorption coefficient of the film is changed. That is, the refractive index of the film changes. In addition, since Ag particles in the film react with halogenated ions to form insulated silver halide, the resistivity of the film also changes. Since the transmittance of the film can be changed as mentioned above, it becomes possible to compensate the difference in transmittance of panel in the flat cathode-ray tube.

When a layer having electroconductivity (e.g. ITO, ATO, Ag, Au, Pd, etc.) is formed on the surface treating film, it is possible to form an antistatic layer. Further, by forming a layer having a low refractive index (e.g. a SiO₂ layer) on the antistatic layer, it is possible to form an antireflective antistatic film by applying optical interference effects. By applying an antistatic film, and/or antireflective antistatic film on the surface treating film controlling optionally the transmittance of the film as mentioned above, it is possible to enhance performance of the flat cathode-ray tube.

It is also possible to form a wavelength selective absorption film having various organic dyes for contributing to higher contrast of the film on the surface treating film. Such a film can be formed by a film forming method using a coating solution with a low cost.

The present invention is illustrated by way of the following Examples, but needless to say, the present invention is not limited thereto.

### EXAMPLES

After cleaning a flat cathode-ray tube (46 cm; panel transmittance: about 78% in a central portion, about 67% in a peripheral portion; panel thickness: about 11.5 mm in a central portion, about 24.5 mm in a peripheral portion) by a conventional cleaning method usually used in a conventional sol-gel method, the panel surface temperature after dried was adjusted to about 35 ±1° C., followed by coating with the following solution.

A uniform solution was obtained by adding 20 ml of an ethanol solution (2% by weight) of chloropropyltri-alkoxysilane and bromopropyltrialkoxysilane (3:7) to 100 ml of a dispersion of Ag ultrafine colloid, followed by addition of 10 ml of a silica sol liquid (1% by weight). This solution was spin coated on the flat cathode-ray tube for 30 seconds revolving at 150 rpm, followed by drying at 60° C for 1 minute. After placing a quartz plate having a metallic semi-transparent filter therein and a transmittance distribution of 100% of central transmittance and 0% peripheral transmittance between the panel surface of the cathode-ray tube and an ultraviolet rays source, the ultraviolet rays were irradiated with 365 nm and intensity of 20 W/m² for 60 seconds. By this, Ag in the film reacted with activated chlorine and bromine to produce silver halides.

The thus obtained surface treating film had a transmittance of 91% in the central portion, and the transmittance of the irradiated portion was 80% at the peripheral portion which was most strongly colored, resulting in causing a difference of about 11% of the transmittance compared with the central portion. By this, it became possible to compensate the difference in panel transmittances of the flat cathode-ray tube. The resulting film had a surface resistance of 12000 Ω/unit square in the central portion and that of 1100 Ω/unit square in the peripheral portion.

Further, on this film, a dispersion of Ag—Pd—Au ultrafine particle colloid (1% by weight) was spin coated at 150 rpm for 30 seconds, while adjusting the temperature of the surface of the cathode-ray tube at 45±1° C.

Then, a SiO₂ sol liquid (0.8% by weight) was spin coated under the same conditions as mentioned above. The resulting film was heat treated at 160° C. for 30 minutes. The thus produced surface treating film having a laminated structure had a surface resistance of 850 Ω/unit square in the central portion and that of 560 Ω/unit square in the peripheral portion. Further, this film had a visual reflectance of 0.4% in the central portion and that of 0.9% in the peripheral portion. In addition, this surface treating film was remarkably excellent in interception and reflection preventing ability for leaked electromagnetic wave.

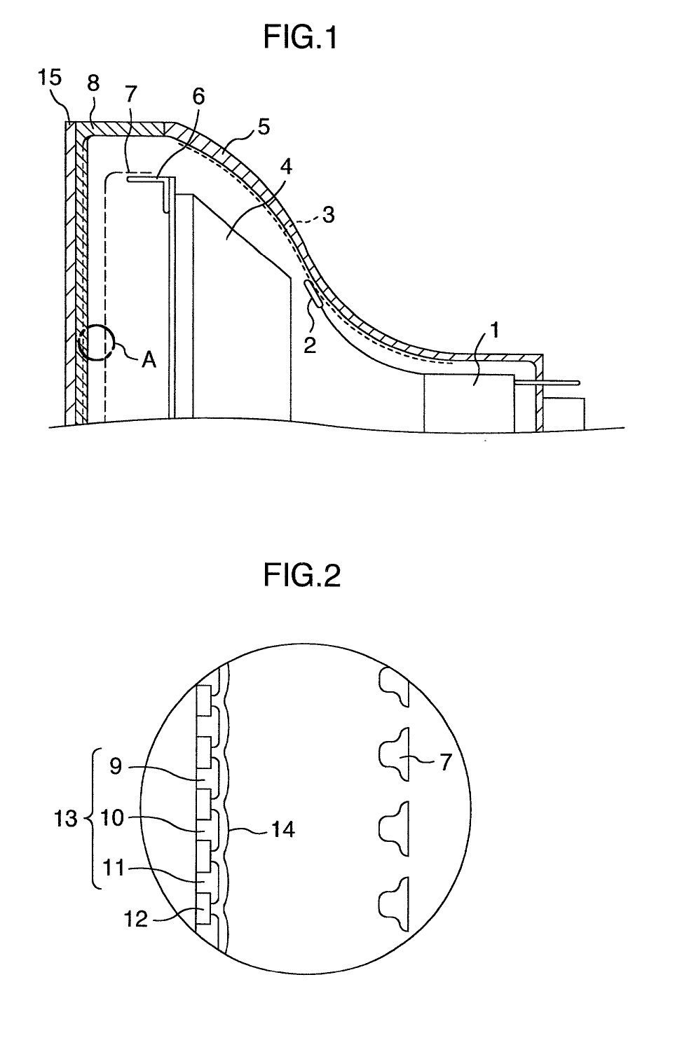

FIG. 1 is a cross-sectional view of a half of the flat cathode-ray tube having a surface treating film 15 comprising a three-layered antireflective, antistatic, inclined absorption film thus obtained, wherein the inclined absorption film, the metallic electroconductive film and the SiO₂ film having a low refractive index are laminated in this order from inside to outside of the surface of the cathode-ray tube.

In FIG. 1, numeral 1 denotes an electron gun, numeral 2 denotes an antenna getter, numeral 3 denotes an interior decorative graphite layer, numeral 4 denotes an inner shield, numeral 5 denotes a funnel, numeral 6 denotes a frame, numeral 7 denotes a mask, numeral 8 denotes a panel, numeral 9 denotes a green phosphor, numeral 10 denotes blue phosphor, numeral 11 denotes red phosphor, numeral 13 denotes phosphors, numeral 12 denotes a black matrix, numeral 14 denotes aluminum, and numeral 15 denotes a surface treating film. FIG. 2 is an enlarged view of A in FIG. 1.

According to the Examples of the present invention as mentioned above, by forming the surface treating film having changed light transmittance in an inclined state by means of UV irradiation on the outer surface of the cathode-ray tube, the differences of transmittance of the panel in the central portion and the peripheral portion can easily be compensated. Further, by forming the antistatic layer using metal colloid, and forming the SiO₂ layer having a low refractive index upon the underlying surface treating layer, it becomes possible to form a highly functional antireflective antistatic film having a low surface resistance and a low surface reflection, resulting in providing a highly functional flat cathode-ray.

Alernately, it is possible to produce a similar antireflective antistatic film by using a dispersion (3% by weight) of ITO ultrafine colloid in place of the dispersion of Ag—Pd—Au ultrafine colloid, although the antistatic ability is slightly lowered.

According to the present invention, there can be provided the display device having a surface treating film with a small difference in emission intensity by compensating light transmittances in the central portion and the peripheral portion of the substrate, the process for producing such a display device, and the flat cathode-ray tube applying such a display device.

What is claimed is:

1. A display device comprising a substrate for displaying an image and a surface treating film formed on a surface of the substrate, said surface treating film having a property of changing transmittance or refractive index by light.

2. A display device comprising a substrate for displaying an image and a surface treating film formed on a surface of the substrate, said surface treating film having a property of changing transmittance or refractive index by ultraviolet rays.

3. A display device comprising a substrate for displaying an image and a surface treating film formed on a surface of the substrate, said surface treating film containing a compound which is deposited by irradiation with light.

4. A display device comprising a substrate for displaying an image and a surface treating film formed on a surface of the substrate, said surface treating film containing a compound which is deposited by irradiation with ultraviolet rays.

5. A display device according to claim 1, wherein the surface treating film has partially different light transmittance.

6. A display device comprising a substrate for displaying an image and a surface treating film formed on a surface of the substrate, said surface treating film containing silver and a halide and having partially different light transmittance.

7. A display device according to claim 1, wherein the surface treating film contains SiO₂ and a derivative thereof.

8. A display device according to claim 1, wherein the surface treating film has a light transmissible electroconductive layer thereon.

9. A dispaly device according to claim 8, wherein the electroconductive layer has a SiO₂ film having a low refractive index thereon.

10. A process for producing a display device, which comprises
coating a solution comprising at least one silver compound and a halogen compound on a surface of a substrate for displaying an image, and
irradiating the coated surface with light changing irradiation intensity partly to form a surface treating film.

11. A process for producing a display device, which comprises
coating a solution comprising ultrafine particles of metal, an alkoxysilane compound and silica sol on a surface of a substrate for displaying an image,
drying the coated surface, and
irradiating the coated surface with ultraviolet rays changing irradiation intensity partly to form a surface treating film.

12. A flat cathode-ray tube including a phosphor screen therein, which comprises a surface treating film formed on an outer surface of the cathode-ray tube, said surface treating film having smaller light transmittance in a central portion than that in a peripheral portion and containing a silver halide compound.

13. A flat cathode-ray tube including a phosphor screen therein, which comprises a surface treating film formed on an outer surface of the cathode-ray tube, said surface treating film having larger surface resistance in a central portion than that in a peripheral portion and containing a silver halide compound.
